(19) United States
(12) Patent Application Publication
(10) Pub. No.: US 2003/0184300 A1
(43) Pub. Date: Oct. 2, 2003

(54) underground locator with a laser marking device.

(76) Inventor: Russell N. Bigelow, Half Moon Bay, CA (US)

Correspondence Address: Finnegan Henderson Farabow Garrett & Dunner, LLP, 1300 I Street, N.W., Washington, DC, 20005-3315, US

(21) Appl. No.: 10/116,614

(22) Filed: Apr. 2, 2002

(51) Int. Cl. G01V 3/08

(52) U.S. Cl. 324/326

(57) ABSTRACT

A device with a laser pointer for locating concealed objects is presented. In some embodiments, the device is a line locator. In some embodiments, the device is a marker locator. In some embodiments, the laser pointer can provide an indication on the surface over the concealed object so that the surface can be easily marked. In some embodiments, the laser pointer can be utilized as a range finder to find the distance between a landmark and the device, which can be utilized to triangulate a position of the concealed objects.

### BACKGROUND

1. Field of the Invention

The invention relates to a device used to locate concealed objects and, in particular, to a device with a laser pointer for locating concealed objects.

2. Background

It is often necessary to locate concealed objects such as those buried in the ground. Objects buried in the ground must be located before they can be maintained or protected. They must also be located and repaired or replaced when they fail. Additionally, buried objects must be located and protected from damage when excavation is taking place nearby. Some examples of buried objects that are of concern include electrical power lines, fiber optic cables, telephone lines, pipes that carry natural or other gas, product pipes that carry petroleum or other products, and pipes that carry water or other fluids.

In addition to protecting the buried object, location is required for the safety of the excavator and others around the excavation. Every year within the United States property is destroyed and people are injured or killed when an excavator digs into a natural gas line or digs into a power line carrying high voltage. There are legal requirements in many states that require an excavator to call a clearance center within a set time prior to excavation. For example, in some states the excavator must call a One Call Center at least 48 hours before excavation can begin. The One Call Center will insure that all of the utilities at the excavation site are located and marked on the ground to prevent damage to property or injury to persons.

There are several common methods used to locate concealed objects including the detection of magnetic fields generated by the object, detection of a change in the earth's magnetic field due to the presence of a concealed object, detection of an electrical potential on the surface of the ground above a buried object, or detection of the sound caused by the leakage of a fluid or other physical effect.

An electrically conducting object (a line) may be made to radiate electromagnetic energy by being conductively connected to an external transmitter or by being inductively coupled to an external transmitter. In some instances, such as with electrical power lines, the line may radiate without an external transmitter. In other instances where, the line is not an electrical conductor, a marker containing an electrically resonant circuit can be placed proximate to the line so that it will react with an electromagnetic field emitted from a marker locator.

An example of a conventional line locator device 1 is shown in FIG. 1. FIG. 1 shows a line 4 beneath ground surface 7 that is radiating a magnetic field 5. Line locator device 1 is held by operator/technician 6 over line 4. Line locator device 1 includes sensor 3 that detects magnetic field 5 and displays a signal on a display 2 that is indicative of the magnetic field strength at sensor 3. Depending on the orientation of sensor 3 (i.e., whether it is sensitive to horizontal or vertical components of the magnetic field), display 2 will indicate a maximum signal or a minimum signal when line locator device 1 is held directly above line 4 (where the magnetic field 5 is directed substantially horizontally).

When device 1 indicates that it is directly over buried line 4, the position corresponding to the centerline of buried line 4 must then be estimated and accurately marked on ground 7. At present this is done by eye, wherein locating technician 6 estimates where locator device 1 is pointing and uses a spray can of paint to paint the approximate position of the center of line 4. Human error in estimating where locator device 1 is pointing can cause inaccurate markings. The accuracy of the markings made prior to excavation is important to avoid damage to lines 4 and danger to those carrying out the excavation. Where excavation is close to power lines, there is a serious risk of electrical shock if the line is not accurately marked. There are also risks to property from damaging power lines, water pipes, or other underground utility lines.

Locating the position of a concealed object such as a line requires the operator to walk around the area in question while monitoring the display of the locator for an indication that the locator is directly over the object. The locating technician must walk across the ground at a rapid pace watching both the display of the locator and listening to an audible sound. Surface 7 over which the technician walks is often uneven, may contain hazards such as holes or snakes. Technician 6 must often work on busy streets with heavy traffic, technician 6's attention must be divided between operating device 1 and taking precautions not to be hit by a vehicle. When working in heavy traffic the noise may also make it difficult or impossible to hear the audible tone from device 1.

Once the concealed object 4 is marked it is often necessary to locate object 4 by measuring distances to several reference points around the object 4. This additional marking is required in order to assign liability in the event that damage does occur and the original paint markings are lost during excavation. At present this additional marking is achieved by using a tape measure and measuring the distance to several reference points near object 4. This method consumes considerable time and effort since technician 6 must put down device 1 and walk between the marking and the landmark to extend the tape.

Therefore, there is a need for a device for locating buried objects that clearly and accurately indicates the location of a buried object on the ground directly above the object. There is also a need for a device that provides information to the operating technician in a safe manner while the device is being operated over rough terrain or in areas with heavy automobile traffic. In addition, there is a need for a quick and accurate way of measuring the distance between the located object and nearby landmarks for later reference.

### SUMMARY

In accordance with the present invention, a device for locating concealed objects is disclosed that has a laser pointing device. In some embodiments, the laser pointing device indicates the position on the ground, or concealing surface, to which the locator points. The visible laser beam from the device can be used to clearly indicate the location of the concealed object or buried line on the surface. The operator of the device can see the precise location without checking a display, and the object can be accurately marked.

In some embodiments, the laser pointing device can also be used to visually convey information on the surface in front of the device, so that the operator does not have to look at a display while traversing the search area. The shape or color of the beam from the laser pointer can change to indicate operational status to the operator, for example that the buried line is to the right or left, that the battery is low, that the center line has been located, that field distortion has been detected, that the locate indication is not accurate or other information.

In some embodiments, the laser pointer device can be used to measure the distance to landmarks located around the concealed object, thereby eliminating the need to put the locator down and use a tape measure. Measurement of distance by the laser may be accomplished, for example, by modulating the laser beam and using a receiver within the locator to intercept the light reflected from the landmark and estimating the distance to the landmark by processing the signal of the laser beam.

In some embodiments, the laser pointer device can be utilized both for indicating the underground object on the surface and also for measuring the distance between the locating device and a landmark.

These and other embodiments are more fully explained with respect to the following figures.

### BRIEF DESCRIPTION OF THE FIGURES

FIG. 1 (prior art) shows a diagram of a line locator device used by an operator/technician to locate an underground line.

FIG. 2 shows a diagram of a device with a laser pointing device indicating the location of a buried object in accordance with aspects of the present invention.

FIG. 3 shows a diagram of a device according to the present invention with a laser pointing device and a laser receiver, used to measure the distance between the device and a landmark.

FIG. 4 shows a diagram of a device according to the present invention with a laser pointing device indicating the location of the buried object and a laser receiver, used to measure the distance between the device and a landmark.

FIG. 5 shows a diagram of a marker locating device with a laser pointing device indicating the location of the buried marker.

FIG. 6 shows a diagram of a marker locating device according to the present invention with a laser pointing device indicating the location of the buried marker and a laser receiver, used to measure the distance between the device and a landmark.

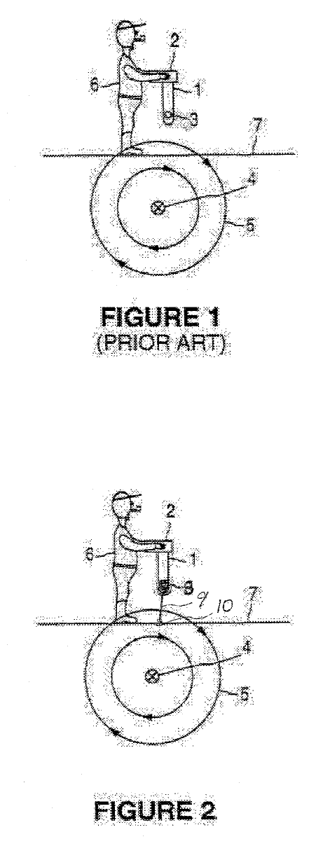

In the figures, elements having the same designation have the same or similar function.

### DETAILED DESCRIPTION OF THE INVENTION

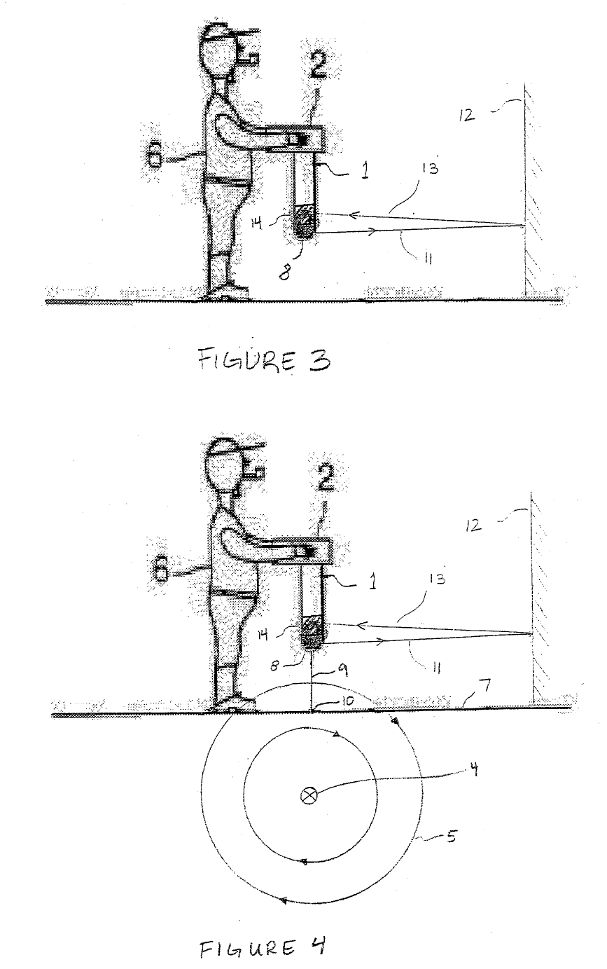

FIG. 2 shows a line 4 beneath a surface 7 that is radiating a magnetic field 5. A locator device 1 is held over surface 7 by operator 6. When locator device 1 determines that it is directly over line 4, a beam 9 visible on surface 7 is generated from laser pointing device 8 to indicate an area 10 on surface 7 that is directly above the centerline of buried line 4.

Use of laser pointing device 8 can avoid the need to rely on the judgment of operator 6 as to where device 1 is pointing when line 4 is located. Pointing device 8 can be sighted so that laser beam 9 indicates where line locating device 1 is pointed by illuminating surface 7 below locating device 1. Locating device 1 indicates when laser beam 9 is held directly above the concealed line. Paint or other forms of markings can then be applied over visible laser beam 9 to mark area 10. This marking can be done quickly and accurately. In some embodiments, laser beam 9 is always present.

In some embodiments, laser beam 9 can be utilized to convey useful information to operator 6. Information that is normally available only on display 2 can be displayed on surface 7 at the illuminated area 10. This display may be observed by operator 6 without directing attention away from surface 7, to aid operator 6 while walking. Information that can be provided through laser pointer 8 and laser beam 9 includes, but is not limited to, giving directional guidance towards buried line 4, indicating a low-battery condition, indicating a distorted field, or indicating that bleed-over condition has occurred and that operator 6 is following the wrong buried line. Laser pointing device 8 can convey information. Any modification to beam 9 that would produce a clearly visible change to operator 6 can be utilized to convey information. Information can be conveyed on laser beam 9 by changes of color of beam 9, changes in shape of beam 9, spatial variation (scanning pattern) of beam 9, temporal variation (temporal modulation of intensity or color) of beam 9 or by any other physical effect. The physical modification of laser beam 9 would be well understood by a person of ordinary skill in the art. This allows operator 6 to keep his attention on surface 7 and thus reduces the risk of injury while following a search pattern over surface 7.

In some embodiments of the present invention, multiple sensors are used to gather more electromagnetic field data, which can be used to determine the depth of the buried line or whether the line is to the left or right of the locator. Depth determination and left/right determination in a line locator is described in U.S. Pat. No. 5,001,430, “Apparatus for locating concealed electrical conductors,” issued to Peterman et al., Mar. 19, 1991, herein incorporated by reference in its entirety. Further methods of locating line 4 are described in U.S. Pat. No. 6,130,539, “Automatic Gain Control For A Line Locator” to Steven Polak, U.S. application Ser. No. 09/136,767, and “Line Locator Having Left/Right Detection” to Gopalakrishnan Parakulam and Steven Polak, each of which are assigned to the assignee of the present invention and all of which are hereby incorporated by reference in their entirety.

FIG. 3 shows an operator 6 with a locator device 1 according to the present invention. A laser pointing device 8 directs a laser beam 11 towards an object 12 used as a landmark. The reflected beam 13 from the landmark is then detected by detector 14 and analyzed to determine the distance between the locator 1 and the landmark 12. By measuring the distance to two or more landmarks, the position of locator 1 may be determined, which corresponds with the position of buried line 4 as shown in FIG. 2. Such laser rangefinders based on the principle of reflected laser light are common. An example is the Advantage, made by Laser Atlanta Optics, Inc. It should also be understood that any general rangefinder would be applicable to the present invention. The construction and use of rangefinders is well known to one skilled in the art.

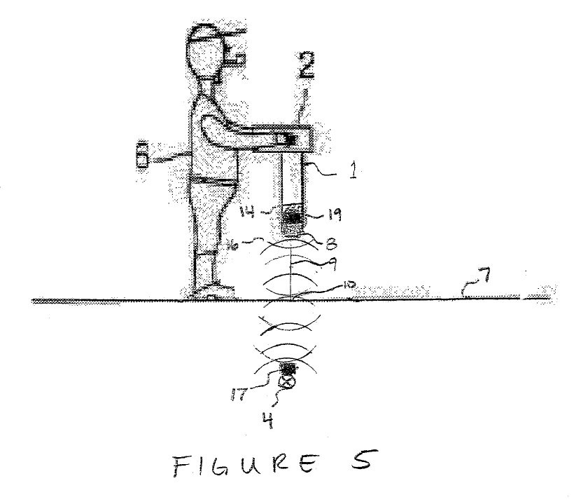

FIG. 4 shows an embodiment of line locator device 1 in accordance with the present invention in which laser pointing device 8 provides laser beam 9 for marking area 10 and also a range finding feature.

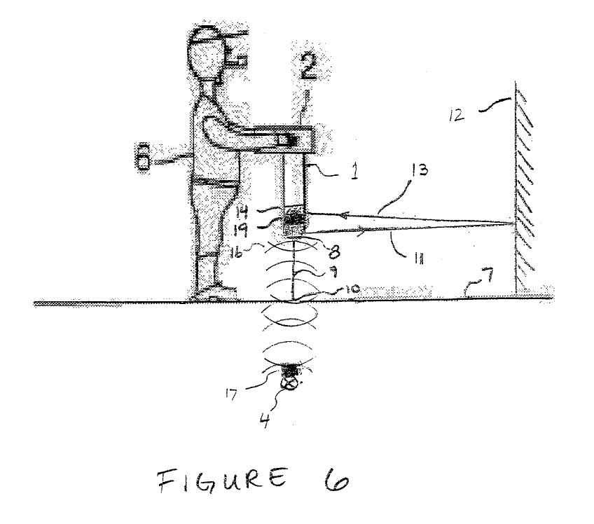

FIG. 5 shows another embodiment of the present invention. In the embodiment shown in FIG. 5 locator device 1 is a marker locator for locating marker 17, which is positioned adjacent to object 4. To locate a line 4, marker locator device 1 is held over surface 7 by operator 6. Transmitter 19 of marker locator device 1 radiates a radio frequency signal 16 in the vicinity of object 4. Signal 16 induces electrical energy in a marker 17 that is located near object 4. The electrical energy of marker 17 is detected by detector 14 located in marker locator device 1. When detector 14 determines that it is directly over marker 17, laser beam 9 from laser pointing device 8 visibly illuminates an area 10 that is directly above the centerline of the buried object 4.

FIG. 6 shows another possible embodiment of the marker locator in which laser pointing device 8 of FIG. 5 includes a rangefinder function so that the position of locator device 1 could be indicated while the rangefinding feature is in use.

Other embodiments of this invention will be obvious to one of ordinary skill in the art in light of the above examples. Obvious variations include using the locator to locate lines that are not buried in the ground but are otherwise concealed, for example, in walls or ceilings. Other variations are also obvious to one skilled in the art and are included within the scope of this invention. As such, this invention is limited only by the following claims.

We claim:

1. A locating device for locating a concealed object, comprising:
a detector that detects the location of a concealed object; and
a laser pointing device.

2. The locating device of claim 1, wherein the concealed object is a conductor.

3. The locating device of claim 1, further comprising a transmitter, wherein the transmitter generates a radio frequency signal.

4. The locating device of claim 3, wherein the concealed object is a marker that responds to the radio frequency signal by radiating an electromagnetic field.

5. The locating device of claim 3, wherein the concealed object is located by means of locating the source of an acoustic sound emanating from the object.

6. The locating device of claim 1, wherein the laser pointing device directs a laser beam wherever the locating device is pointed to visually indicate an area directly above the concealed object when the detector indicates the concealed object.

7. The locating device of claim 1, wherein the laser pointing device modifies the laser beam to provide information.

8. The device of claim 7, wherein information includes an indicating that the detector is above the concealed object.

9. The device of claim 7, wherein information includes indication of a direction towards a point above the concealed object.

10. The device of claim 7, wherein information includes indication of operational status of the device.

11. A locating device for locating a concealed object comprising:
a laser pointing device that directs a laser beam at a landmark; and
a detector that detects the location of a magnetic field that is radiated from the concealed object;
wherein the detector further detects the laser beam reflected from the landmark and determines the distance between the detector and the landmark.

12. The locating device of claim 11, wherein the concealed object is a conductor.

13. The locating device of claim 11, further comprising a transmitter, wherein the transmitter generates a radio frequency signal.

14. The locating device of claim 13, wherein the concealed object is a marker that responds to the radio frequency signal by radiating an electromagnetic field.

15. The locating device of claim 11, wherein the laser pointing device directs a second laser beam wherever the locating device is pointed to visually indicate an area directly above the concealed object.

16. The locating device of claim 15, wherein the laser pointing device modifies the second laser beam to provide information.

17. A method of locating a concealed object that emits a magnetic field comprising:
detecting the magnetic field;
pointing a laser beam in the direction of the magnetic field to illuminate an area above the concealed object; and
physically marking the illuminated area when the laser beam is directly above the concealed object.

18. The method of claim 17, further comprising the step of modifying the laser beam to provide information on the area above the concealed object.

19. A method of locating a concealed object that emits a magnetic field comprising:
determining the location of the concealed object by detecting the magnetic field;
pointing a laser beam at a landmark, wherein the landmark reflects the laser beam; and
analyzing the laser beam reflected from the landmark to determine the distance between the concealed object and the landmark.

20. The method of claim 19, further comprising:
pointing a second laser beam in the direction of the magnetic field to illuminate an area above the concealed object; and
physically marking the illuminated area when the laser beam is directly above the concealed object.

21. The method of claim 20, further comprising modifying the second laser beam to provide information on the area above the concealed object.
